(19) United States
(12) Patent Application Publication
(10) Pub. No.: US 2016/0026069 A1
(43) Pub. Date: Jan. 28, 2016

(54) Focal Plane Shutter and Camera

(71) Applicant: NIDEC COPAL CORPORATION, Tokyo (JP)

(72) Inventors: Yusuke TOGO, Tokyo (JP); Yasuo TANAKA, Tokyo (JP)

(73) Assignee: NIDEC COPAL CORPORATION, Tokyo (JP)

(21) Appl. No.: 14/611,594

(22) Filed: Feb. 2, 2015

(30) Foreign Application Priority Data
Jan. 31, 2014 (JP) 2014-016669

(51) Int. Cl. G03B 9/64; G03B 9/40

(52) U.S. Cl. CPC G03B 9/64; G03B 9/40

(57) ABSTRACT

A focal plane shutter includes: a bottom board having an opening portion; blade members; main driving members biased in the direction of carrying out a shutter operation of the blade members; a setting member that sets the main driving member to a setting position prior to the shutter operation, against the biasing force; following driving members connected to the blade members, biased to follow the main driving members, and moved by being pushed by the main driving members at the shutter operation; and a constraining mechanism that constrains movement of the following driving member so that the blade members are held in the closed state. The constraining mechanism engages the following driving member biased to constrain the movement thereof, and also includes a constraining member that moves to release the constraint on the main driving member through the engagement thereof prior to the setting member completing the setting operation.

### CROSS REFERENCE TO RELATED APPLICATION

This application claims priority under 35 U.S.C. §119 to Japanese Patent Application No. 2014-016669, filed on Jan. 31, 2014, the entire content of which being hereby incorporated herein by reference.

### FIELD OF TECHNOLOGY

The present invention relates to a focal plane shutter for a camera that has a blade member for opening and closing and opening portion for exposure, for exposure, and, in particular, relates to a focal plane shutter in a camera, such as a digital single-lens camera, a mirrorless camera, or the like that is provided with an imaging element, wherein a first blade and a second blade are provided as blade members wherein a state can be maintained wherein, prior to imaging, the first blade is opened so as to enable an image of a photographic subject to be observed using an electronic finder, and, after imaging, the second blade is closed and the imaging information is transferred to a storing portion, and relates to a camera that uses said focal plane shutter.

### BACKGROUND

There is a conventional focal plane shutter comprising: an essentially rectangular bottom board having an opening portion for exposing; a first blade and a second blade that are supported so as to be able to move relative to the bottom board so as to open and close the opening portion of the bottom board; a first blade first driving member (a first blade following driving member) that is connected to the first blade and that is biased, in the direction of closing the first blade, by a biasing force such as an anti-backlash spring, or the like, of the first blade; a first blade second driving member (a first blade main driving member) that is disposed coaxially with the first blade first driving member; a first blade driving spring for rotationally biasing the first blade second driving member in the direction for opening the first blade by pushing the first blade first driving member at the time of shutter operation; a second blade first driving member (a second blade following driving member) that is connected to the second blade and that is biased, in the direction of opening the second blade, by a biasing force such as, for example, a second blade anti-backlash spring; a second blade second driving member (a main second blade driving member), disposed coaxially with the second blade first driving member; a second blade driving spring for rotationally biasing the second blade second driving member in the direction of closing the second blade by pushing the second blade first driving member at the time of shutter operation; a setting member for performing a setting operation for setting, to a setting position for prior to a shutter operation (an exposing operation), the first blade second driving member and the second blade second driving member; a stopping member (a first blade constraining member) for constraining the movement of the first blade first driving member so as to hold, in the open position, the first blade at the time of the setting operation prior to imaging (so as to be normally open); and a engaging member (a second blade constraining member) for constraining the movement of the second blade first driving member so as to hold the second blade in a closed position at the time of a setting operation after imaging; wherein: an image of a photographic subject can be observed prior to imaging using an electronic finder; and wherein imaging information can be transferred to a storing portion at the beginning of the setting operation after imaging. See, for example, Japanese Unexamined Patent Application Publication No. 2012-177765.

However, in this focal plane shutter, the structure is such that the operation for releasing the stopping by the stopping member and the operation for releasing the engagement by the engaging member are each linked to the setting operations of respective setting members, and the second blade first driving member, the engaging member, the first blade first driving member, the stopping member, and the setting member have rotational centers that are positioned at respectively different positions, and thus there are constraints on the respective arrangement relationships in order to cause the setting member to be linked to both the stopping member and the engaging member and to produce the operation for disengaging the stopping member and the first blade first driving member and the operation for disengaging the engaging member and the second blade first driving member, so the shape of the setting member is complex, and thus, for this reason, there is little design flexibility in the arrangement of the various members, making it difficult to simplify the structures, reduce the components, and miniaturize the device.

The present invention was created in contemplation of the situation forth above, and an aspect thereof is to provide a focal plane shutter that is well-suited to a digital camera such as a digital single lens camera or a mirrorless camera, or the like, wherein, while simplifying the structure, reducing the components, and achieving miniaturization of the device, the transfer and storing of imaging information is carried out at the time of the setting operation to enable continuous imaging at a high speed, and wherein an electronic finder can be used to observe an image of a photographic subject prior to imaging, and to provide a camera using such a focal plane shutter.

### SUMMARY

A focal plane shutter according to the present invention comprises: a bottom board having an opening portion for exposing; a blade member for opening/closing the opening portion; a main driving member for biasing the blade member in the direction of carrying out a shutter operation; a setting member able to set the main driving member to a setting position for prior to a shutter operation, against the biasing force; a following driving member that is connected to the blade member and that is biased so as to follow the main driving member that is set to the setting position, and that is pushed by the main driving member so as to move at the time of a shutter operation; and a constraining mechanism for constraining the movement of the following driving member so as to hold the blade member in a closed state; wherein: the constraining mechanism includes a constraining member that engages the following driving member and that is biased so as to constrain the movement thereof, and that is moved so as to release the constraint through engaging the main driving member prior to completion of the setting operation by the setting member. Given this structure, when the main driving member moves towards the setting position, through a setting operation of the setting member, from the state wherein the shutter operation has been completed (the exposing operation has been completed) wherein the blade member has closed the opening portion, the following driving member is constrained by the constraining member to maintain a closed state, where the constraint of the following driving member by the constraining portion is released prior to the completion of the setting operation through engagement by the main driving member, where the following driving member is positioned, by a biasing force, in a state wherein the blade member is released, following the main driving member (which has been set to the setting position), after which the main driving member (and the following driving member) are moved by a biasing force so as to enable the shutter operation (the operation for closing the opening portion) by the blade member (that is, so as to enable a shutter operation by the blade member (a single curtain)). That is, holding the opening portion in a closed state over a prescribed interval following the completion of the shutter operation enables the imaging information to be transferred to, and stored in, the storing portion in parallel with the setting operation, enabling high-speed continuous imaging. In particular, when compared to a structure wherein the constraint is released by the setting member, as has been done conventionally, carrying out the operation wherein the constraining member is released increases the flexibility in design of the arrangement of the various members, enabling simplification of the structure, reduction of the components, and miniaturization of the device.

In the focal plane shutter according to the structure set forth above, a structure may be employed wherein: the following driving member is supported so as to be able to rotate around a first axial line, and has a constrained portion for which movement is constrained by engaging with the constraining member; the constraining member is supported so as to be able to rotate around a second axial line and has a constraining portion for constraining movement by engaging the constrained portion of the following driving member; and the main driving member is supported so as to be able to rotate around the first axial line, and has a cam portion that engages the constraining member so as to exert a cam effect in the direction of releasing the constraint. Given this structure, the main driving member and the following member are arranged rotatably around a common first axial line, and the constraining member is disposed rotatably around a second axial line that is different from the first axial line, so when the main driving member is rotated in one direction by a setting operation by the setting member from a state wherein the constraining portion of the constraining engages the constrained portion of the following driving member so that the rotation of the following driving member 81 direction (in the direction in which the blade member will go to the released state) is constrained, the cam portion of the main driving member exerts a cam effect on the constraining member so that the constraint of the following driving member by the constraining member is released prior to the complete of the setting operation. In this way, the use, as the constraining member, of a structure that is disposed in the vicinity of the main driving member in the following driving member enables the achievement of a simplification in structure, a reduction in components, the miniaturization of the device, and the like.

In the focal plane shutter according to the structure set forth above, a structure may be employed wherein: the following driving member has a sliding portion that is formed continuously with the constrained portion, for sliding on a portion of the constraining member when the constraining portion engages or releases the constrained portion. Given this structure, when the constraining portion of the constraining member engages the constrained portion of the following driving member, the sliding portion of the following driving member slides, and when the constraining portion of the constraining member disengages from the constrained portion of the following driving member, the sliding portion of the following driving member slides, and thus the impact, and the like, when the following driving member (and the blade member) are constrained, and when the constraint is released is mitigated, enabling a smooth constraining operation and operation to reduce the constraint.

In the focal plane shutter according to the structure set forth above, a structure may be employed, including: a stopping mechanism for stopping movement of the following driving member in the opposite direction at the completion of the shutter operation by the blade member; and the constraining mechanism acts also as the stopping mechanism. Given this structure, the constraining mechanism is used also as a stopping mechanism, enabling the achievement of a simplification of structure, miniaturization of the device, and the like, while also enabling both a stopping that prevents rebound, with a constraining effect for holding the blade member (the second blade) in the closed state.

In the focal plane shutter according to the structure set forth above, a structure may be employed wherein: the blade member includes a first blade for opening the opening portion and a second blade for closing the opening portion at the time of a shutter operation; the main driving member includes a first blade main driving member corresponding to the first blade and a second blade main driving member corresponding to the second blade; the following driving member includes a first blade following driving member corresponding to the first blade and a second blade following driving number corresponding to the second blade; the constraining mechanism includes a second blade constraining member that is biased so as to engage the second blade following driving member so as to constrain the movement thereof and that moves so that the constraint, through the engagement of the second blade main driving member, is released prior to the completion of the setting operation by the setting member. Given this structure, when the main driving member for the first blade and the second blade main driving member are moved toward the setting position by a setting operation by the setting member from a shutter operation completed (exposing operation completed) state wherein the first blade has opened the opening portion and the second blade has closed the opening portion, the second blade following driving member is constrained by the second blade constraining member so the second blade is maintained in the closed state while the first blade following driving member follows the main driving member for the first blade so that the first blade begins to close the opening portion, and the constraint of the second blade following driving member by the second blade constraining member is released prior to the completion of the setting operation by the engagement of the second blade main driving member, and the second blade following driving member positions the second blade at the open state following the same second blade driving member (which has been set to the setting position) by the biasing force, enabling the first blade main driving member (and the second blade following driving member) and second blade main driving member (and the second blade following driving member) to each be moved at desired timings by the respective biasing forces, to carry out the shutter operation of the first blade in the second blade (that is, enabling a shutter operation through the first blade (a first curtain) and the second blade (a second curtain) in the normally closed a mode. That is, by the opening portion being held in a closed state by second blade over a prescribed interval after the shutter operation completion, the imaging information can be transferred to, and stored in, the storing portion in parallel with the setting operation, thereby enabling high-speed continuous imaging. Here, in particular, when compared to a structure wherein the strength is released by the setting member, as his conventional, performing the operation for releasing the second blade constraining member by the second blade main driving member that has been set by the setting member enables an increase in the design flexibility in arranging the individual members, making it possible to achieve a simplification in structure, a reduction of components, and miniaturization of the device, and the like.

In the focal plane shutter according to the structure set forth above, a structure may be employed including: a second constraining mechanism for constraining the movement of the first blade following driving member so as to hold the first blade in an open state. Given this structure, the first blade being held in the open state through the second constraining mechanism makes it possible to set a normally open mode wherein an image of the photographic subject can be observed prior to imaging.

In the focal plane shutter according to the structure set forth above, a structure may be employed wherein: the second constraining mechanism includes a first blade constraining member for engaging the first blade following driving member so as to constrain the movement thereof, and an electromagnetic actuator for driving the first blade constraining member. Given this structure, an operation is carried out wherein the constraining member for the first blade is driven by an electromagnetic actuator to perform the constraint and to release the constraint, thus enabling the timing of the constraint and of the release of the constraint to be set easily as appropriate depending on the desired control sequence.

In the focal plane shutter according to the structure set forth above, a structure may be employed including: a second stopping mechanism for stopping movement of the first blade following driving member in the opposite direction at the completion of the shutter operation by the first blade, wherein: the second constraining mechanism acts also as the second stopping mechanism. In this structure, the use of the second constraining mechanism as the second stopping mechanism enables a simplification of structure, a reduction of components, a miniaturization of the device, and the like, while providing both the stopping effect that prevents rebound and the constraining effect for holding the first blade in the open state.

A camera according to the present invention comprises a focal plane shutter of any of the structures set forth above. This structure makes it possible to provide a digital camera such as a digital single lens camera or a mirrorless camera, or the like, wherein, while simplifying the structure, reducing the components, and achieving miniaturization of the device, the transfer and storing of imaging information is carried out at the time of the setting operation to enable continuous imaging at a high speed, and wherein an electronic finder can be used to observe an image of a photographic subject prior to imaging, and to provide a camera using such a focal plane shutter.

The focal plane shutters of the structures set forth above make it possible to provide a focal plan shutter that is well-suited to a digital camera such as a digital single lens camera or a mirrorless camera, or the like, wherein, while simplifying the structure, reducing the components, and achieving miniaturization of the device, the transfer and storing of imaging information is carried out at the time of the setting operation to enable continuous imaging at a high speed, and wherein an electronic finder can be used to observe an image of a photographic subject prior to imaging, and to provide a camera using such a focal plane shutter.

### BRIEF DESCRIPTIONS OF THE DRAWINGS

FIG. 1 is an extra perspective diagram illustrating one example of a focal plane shutter for the present invention.

FIG. 2 is a front view illustrating a state, in the focal plane shutter illustrated in FIG. 1, wherein the blade members (the first blade and the second blade) have completed the shutter operation (the exposing operation).

FIG. 3 is a front view illustrating a state, in the focal plane shutter illustrated in FIG. 2, wherein, in a state wherein the following driving members (the first blade following driving member and the second blade following driving member) which drive the blade members (the first blade and the second blade) are constrained by their respective constraining members (the first blade constraining member and the second blade constraining member), the setting member is beginning the setting operation to rotate in the clockwise direction, with the setting partway completed.

FIG. 4 is a front view illustrating a state, in the focal plane shutter illustrated in FIG. 3, immediately prior to releasing of the constrained by the second blade following driving member through rotation of the second blade constraining member in the counterclockwise direction through the setting member rotating further to engage the second blade main driving member.

FIG. 5 is a front view illustrating a state wherein, in the focal plane shutter illustrated in FIG. 4, the second blade has partially open the opening portion through the constraint of the second blade following driving member being released through further rotation of the setting member.

FIG. 6 is a front view illustrating a (normally open) state, in the focal plane shutter illustrated in FIG. 5, wherein the setting operation has been completed through further rotation of the setting member, where the first blade and the second blade have opened the opening portion.

FIG. 7 is a front view illustrating a blade, in the focal plane shutter illustrated in FIG. 6, wherein the constraint of the first blade following driving member for driving the first blade, by the first blade constraining member, has been released and the first blade has been moved by the biasing force (of the anti-backlash spring) to close the opening portion.

FIG. 8 is a front view illustrating a state wherein, prior to the start of the shutter operation (prior to the start of the exposing operation), in the focal plane shutter illustrated in FIG. 7, the first blade main driving member and the second blade main driving member, which drive the first blade and the second blade, are attracted by respective electromagnets so that the setting member has returned to the standby positioned.

FIG. 9 is a front view illustrating a state wherein, in the focal plane shutter illustrated in FIG. 8, the attractive holding, by the electromagnet, of the first blade main driving member, which drives the first blade, is released so that the first blade main driving member is rotated, by the biasing force (of the first blade driving spring) while pushing the first blade following driving member, so that the first blade starts the shutter operation to open the opening portion.

FIG. 10 is a partial enlarged perspective diagram illustrating, in the focal plane shutter illustrated in FIG. 1, the relationship between the second blade main driving member and the second blade following driving member, which drive the second blade, and the constraining member (the constraining member and biasing spring for the second blade).

FIG. 11 is a partially enlarged front view illustrating a state wherein, in the focal plane shutter illustrated in FIG. 3, the constraining member for the setting blade constrains the following driving for the second blade.

FIG. 12 is a partially enlarged front view illustrating a state wherein, in the focal plane shutter illustrated in FIG. 4, the cam portion of the second blade main driving member engages the second blade constraining member, immediately prior to the constraint of the following second blade driving member being released through the second blade constraining member being rotated in a clockwise direction.

FIG. 13 is a partial enlarged front view illustrating a state wherein, in the focal plane shutter illustrated in FIG. 5, the cam portion of the main driving member for serving blade rotates the second blade constraining member further in the counterclockwise direction to release the constraint of the second blade following driving member.

### DETAILED DESCRIPTION

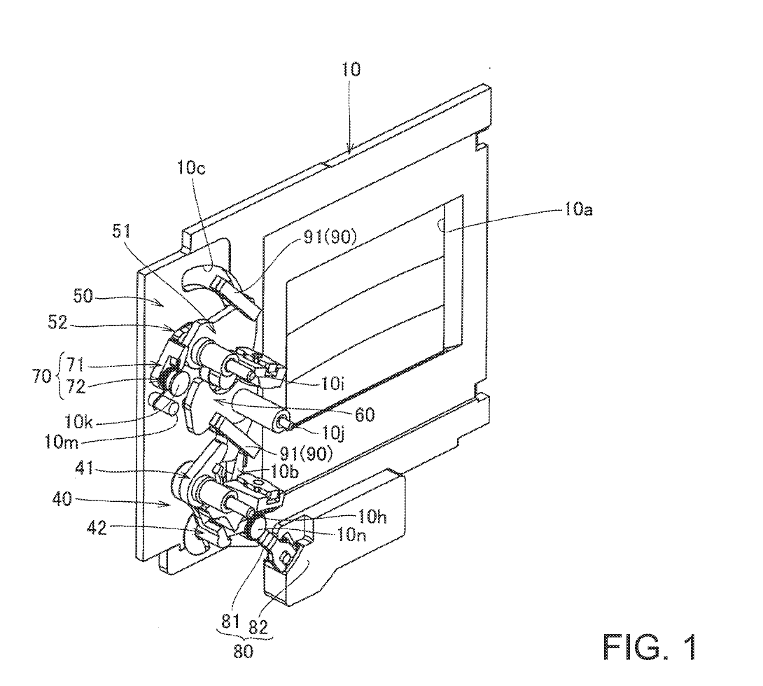

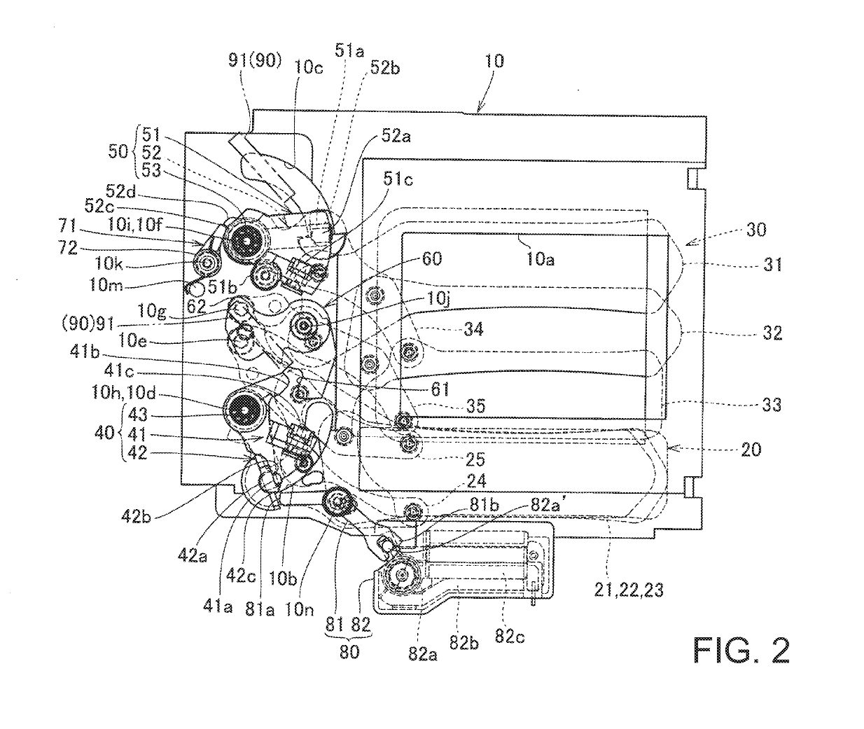

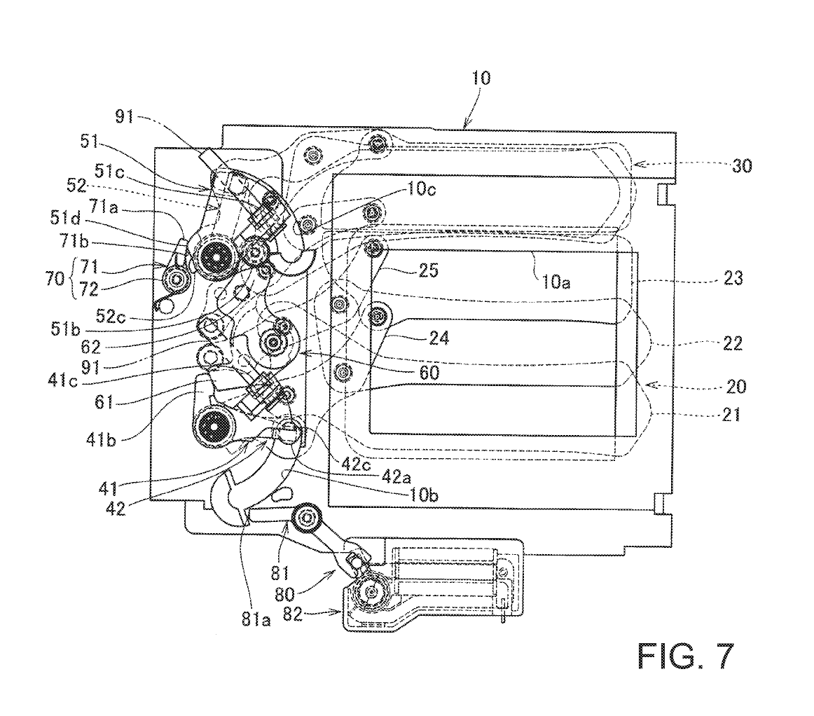

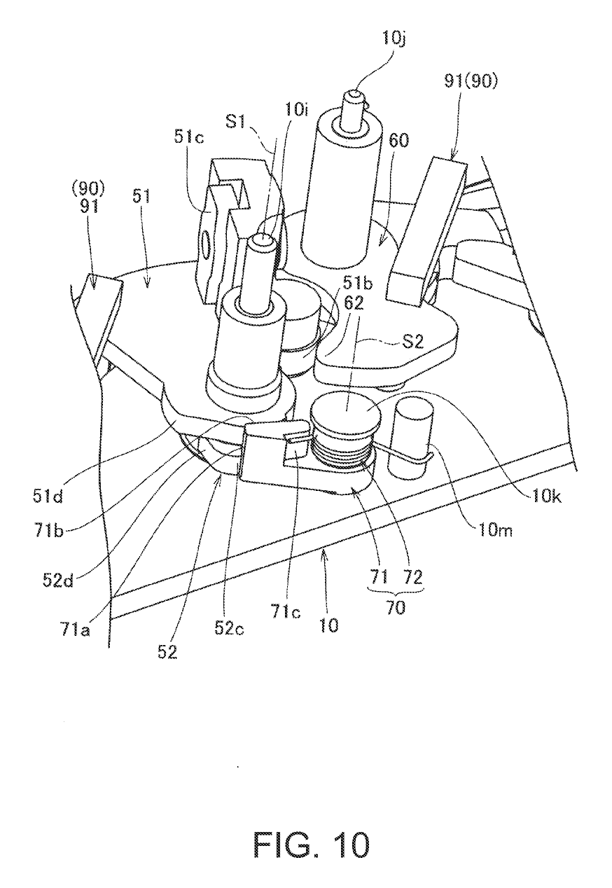

An example according to the present invention will be explained below in reference to the appended drawings. As illustrated in FIG. 1, FIG. 2, FIG. 7, and FIG. 10, the focal plane shutter according to the present example comprises: a bottom board 10; a first blade 20 and a second blade 30, as blade members, that are provided on the bottom board 10 so as to be able to move; a first blade driving member 40 (a first blade main driving member 41, a first blade following driving member 42, and a first blade driving spring 43), for driving the first blade 20; a second blade driving mechanism 50 (a second blade main driving member 51, a second blade following driving member 52, and a second blade driving spring 53), for driving the second blade 30; the setting member 60 capable of setting the main driving members (the first blade main driving member 41 and the second blade main driving member 51) against a biasing force, to the setting positioned for prior to the shutter operation; a constraining mechanism 70 (a second blade constraining member 71 and a biasing spring 72) for constraining the movement of the second blade following driving member 52 (and for functioning also as a stopping mechanism), so as to hold the second blade 30 in a closed state; a second constraining mechanism 80 (a first blade constraining member 81 and an electromagnetic actuator 82) for constraining the movement of the first blade following driving member 42 (and for functioning also as a second stopping mechanism) so as to hold the first blade 20 in the open state; two electromagnets 90 for magnetically attractively holding attracted portions 41c and 51c of the main driving members (the first blade main driving member 41 and the second blade main driving member 51) at the setting position, and the like. Note that on the bottom board 10, an intermediate board (not shown), for defining a blade chamber for containing the first blade 20, and a backboard (not shown), for defining a blade chamber for containing the second blade 30, are secured with prescribed facing to the side (the backside) that is opposite from the front face side on which are disposed the first blade driving mechanism 40, the second blade driving mechanism 50, the setting member 60, and the like.

As illustrated in FIG. 1 and FIG. 2, the bottom board 10 is formed from a resin material, or the like, in an essentially rectangular flat plate shape, and is provided with: an opening portion 10a for exposure; an arc-shaped elongated hole 10b and an arc-shaped elongated hole 10c; supporting shafts 10d and 10e that extend from the blade chamber side (the back side) so as to support the first blade 20 rotatably; supporting shafts 10f and 10g that extend from the blade chamber side so as to support the second blade 30 rotatably; a supporting shaft 10h that extends from the front face side (the side that is opposite from the blade chamber side) so as to support the first blade main driving member 41 and the first blade following driving member 42 rotatably; a supporting shaft 10i (which defines the first axial line S1) that extends from the front face side so as to support the second blade main driving member 51 and the second blade following driving member 52 rotatably; a supporting shaft 10j that extends from the front face side so as to support the setting member 60 rotatably; a supporting shaft 10k that extends from the front face side so as to support the second blade constraining member 71 rotatably; a locking pin 10m that extends from the front face side so as to lock an end portion of a biasing spring 72; a supporting shaft 10n that extands from the front face side so as to support the first blade constraining member 81 rotatably, and the like.

The first blade 20 moves along the bottom board 10, and, as illustrated in FIG. 2 and FIG. 7, is structured from three blade main units 21, 22, and 23, and from two arms 24 and 25 that connect the blade main units 21, 22, and 23. The arm 24 is supported rotatably by the supporting shaft 10c, and a portion thereof is connected to a driving pin 42a of the first blade following driving member 42. The arm 25 is supported rotatably by the shaft 10e. Moreover, the first blade 20 is rotationally biased in the counterclockwise direction by an anti-backlash spring (not shown), such as a torsion coil spring or a tensile spring, or the like (provided leave the arm 24 or 25 and the bottom board 10), and, as illustrated in FIG. 2, the arm 25 is driven, by the first blade main driving member 41 and the first blade following driving member 42 downward (in the clockwise direction) to cause the three blade main units 21, 22, and 23 to overlap to cause the opening portion 10a to be open, where, on the other hand, as illustrated in FIG. 7, is driven by the first blade main driving member 41 and the first blade following driving member 42 upward (in the counterclockwise direction) to deploy the three blade main units 21, 22, and 23 to close the opening portion 10a.

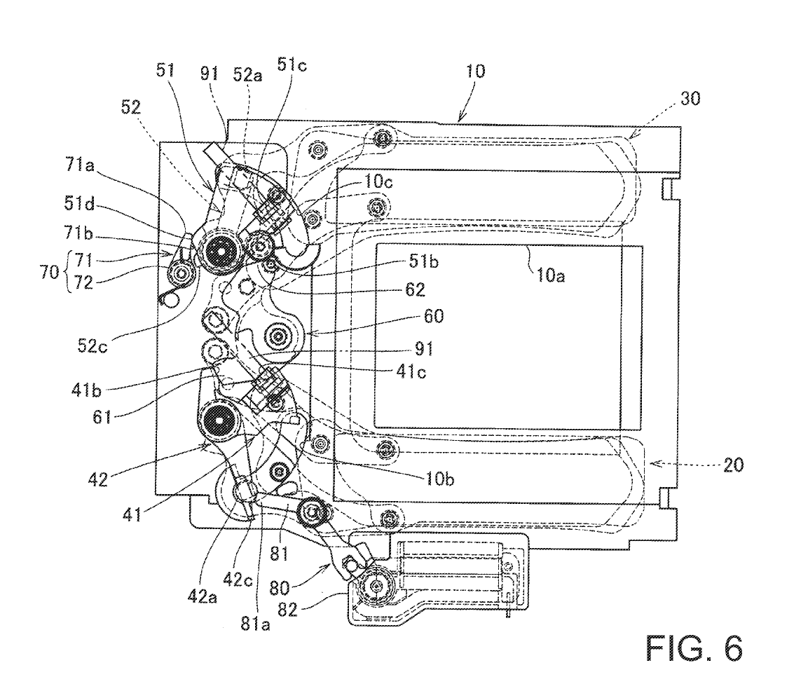

The second blade 30 moves along the bottom board 10, and, as illustrated in FIG. 2 and FIG. 6, is structured from three blade main units 21, 22, and 23, and from two arms 24 and 25 that connect the blade main units 21, 22, and 23. The arm 34 is supported rotatably by the supporting shaft 10f, and a portion thereof is connected to a driving pin 52a of the second blade following driving member 52. The arm 35 is supported rotatably by the shaft 10g. Moreover, the second blade 30 is rotationally biased in the counterclockwise direction by an anti-backlash spring (not shown), such as a torsion coil spring or a tensile spring, or the like (provided leave the arm 34 or 35 and the bottom board 10), and, as illustrated in FIG. 6, the arm 34 is driven, by the second blade main driving member 51 and the second blade following driving member 52 upward (in the counterclockwise direction) to cause the three blade main units 31, 32, and 33 to overlap to cause the opening portion 10a to be open, where, on the other hand, as illustrated in FIG. 2, is driven by the second blade main driving member 51 and the second blade following driving member 52 downward (in the clockwise direction) to deploy the three blade main units 31, 32, and 33 to close the opening portion 10a.

As illustrated in FIG. 2, first blade driving mechanism 40 is structured from a first blade main driving member 41, a first blade following driving 42, a first blade driving spring 43, and the like. As illustrated in FIG. 1 and FIG. 2, the first blade main driving member 41 is provided with an engaging portion 41a for engaging removably the first blade following driving member 42, an engaging portion 41b for engaging the setting member 60 to apply a rotational force in the counterclockwise direction, an attracted portion 41c that is attracted by the electromagnet 90, and the like. Additionally, the first blade main driving member 41 is supported rotatably around a 40 supporting shaft 10h relative to the bottom board 10, and is rotated by the setting member 60 in the counterclockwise direction to be set to a setting position, to be attractively held by the electromagnet 90 at the setting positioned, and is rotated in the clockwise direction, by being pushed by the first blade following driving member 42, through the engaging portion 41a, by the rotational biasing force of the first blade driving spring 43.

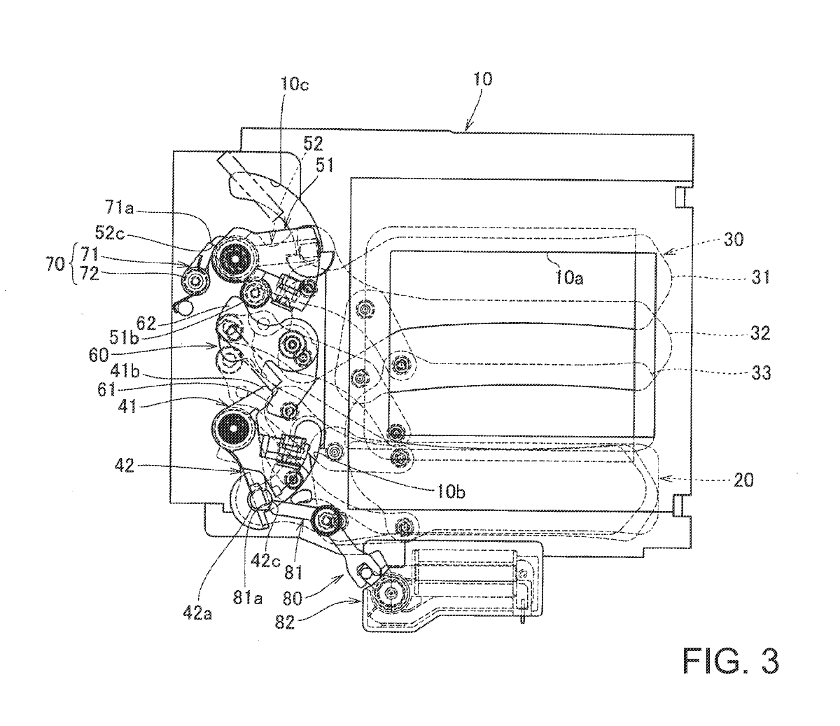

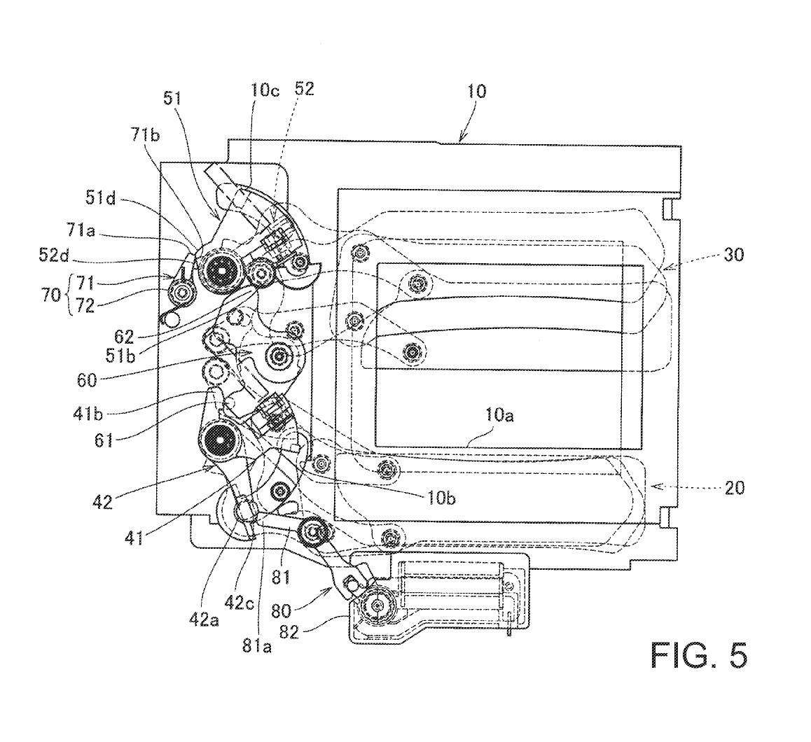

As illustrated in FIG. 1 and FIG. 2, the first blade following driving member 42 comprises: a driving pin 42a that is inserted into the elongated hole 10b and is connected to the arm 24; an engaging portion 42b for engaging removably the engaging portion 41a of the first blade main driving member 41; a constrained portion 42c for engaging removably the constraining portion 81a of the first blade constraining member 81; and the like. The constrained portion 42c, as illustrated in FIG. 3 through FIG. 6, is formed so as to engage removably the constraining portion 81a of the first blade constraining member 81 so as to hold the first blade 20 in the open state wherein the rotation of the first blade following driving member 42 in the counterclockwise direction is constrained. That is, the first blade following driving member 42 is supported rotatably on the supporting shaft 10h relative to the bottom board 10 and is rotationally biased in the counterclockwise direction by an anti-backlash spring that prevents backlash of the first blade 20, where the rotation in the counterclockwise direction is constrained by the first blade constraining member 81 over a prescribed interval of the setting operation by the setting member 60, where, after the completion of the setting operation, the constraint by the electromagnetic actuator 82 is released, to enable rotation in the counterclockwise direction following the first blade main driving member 41 (so that the first blade 20 goes into the closed state), and rotation in the clockwise direction while being pushed by the first blade main driving member 41 through the engaging portion 42b so that the driving pin 42a is stopped by contacting a shock absorbing member that is provided on an end portion of the elongated hole 10b.

The first blade driving spring 43 is a torsion coil-type spring, and, as illustrated in FIG. 2, is disposed around the supporting shaft 10h with one end side arranged so as to enable rotation around the supporting shaft 10h and is locked to a ratchet cylinder (not shown) that is supported by the ratchet pawl (not shown) of a support plate (not shown), (that is, one end side is blocked so as to prevent movement relative to the bottom board 10), where the other end side is locked to a portion of the first blade main driving member 41 so as to exert a biasing force on the first blade main driving member 41 for rotationally biasing in the clockwise direction in FIG. 2.

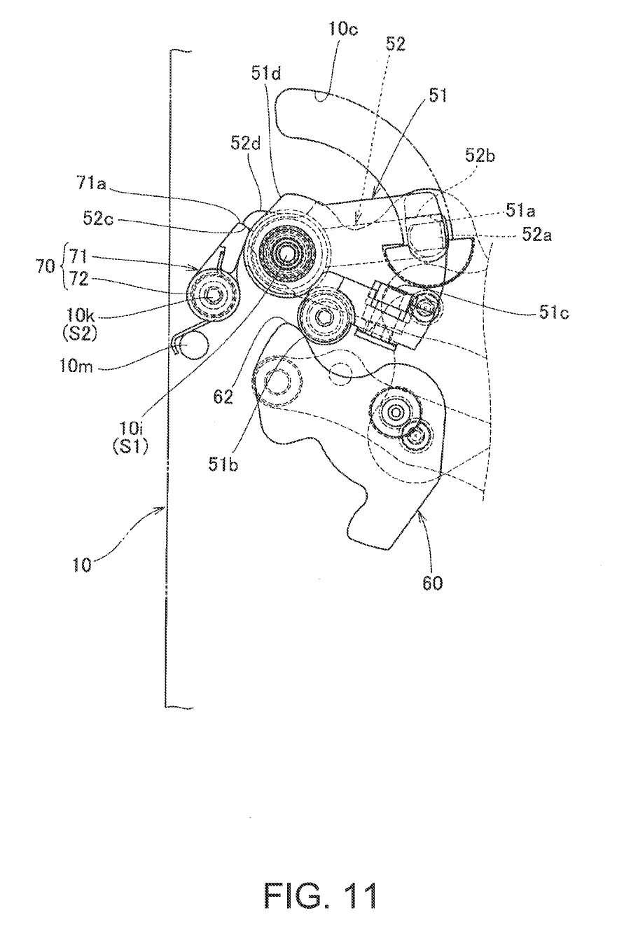

The second blade driving mechanism 50, as illustrated in FIG. 2, is structured from a second blade main driving member 51, a second blade following driving member 52, a second blade driving spring 53, and the like. The second blade main driving member 51, as illustrated in FIG. 1 and FIG. 2, comprises an engaging portion 51a for engaging detachably the second blade following number 52, an engaging portion 51b for engaging the setting member 60 to exert a rotational force in the counterclockwise direction, an attracted portion 51c for being attracted by the electromagnet 90, a cam portion 51d for engaging (the side portion 71b of) the second blade constraining member 71 to exert a cam effect, and the like. The cam portion 51d, as illustrated in FIG. 11 through FIG. 13, engages (the site portion 71b) of the second blade constraining member 71 when the second blade main driving member 51 is rotated in the counterclockwise direction by the setting operation of the setting member 60, to rotate the second blade constraining member 71 in the counterclockwise direction, to exert a cam effect in the direction that releases the constraint of the second blade following driving member 52 by the second blade constraining member 71. That is, the second blade main driving member 51 is supported so as to be able to rotate around the supporting shafts 10i that defines the first axial line S1, relative to the bottom board 10, and not only is rotated in the counterclockwise direction to be set to the setting positioned by the setting member 60, but also the cam member 51d engages the second blade constraining member 71 to release the constraint thereof prior to the completion of the setting operation, and is held in the setting positioned through attraction by the electromagnet 90, so as to be pushed by the second blade following driving member 52 via the engaging portion 51a to be rotated in the clockwise direction by the rotational biasing force of the second blade driving spring 53.

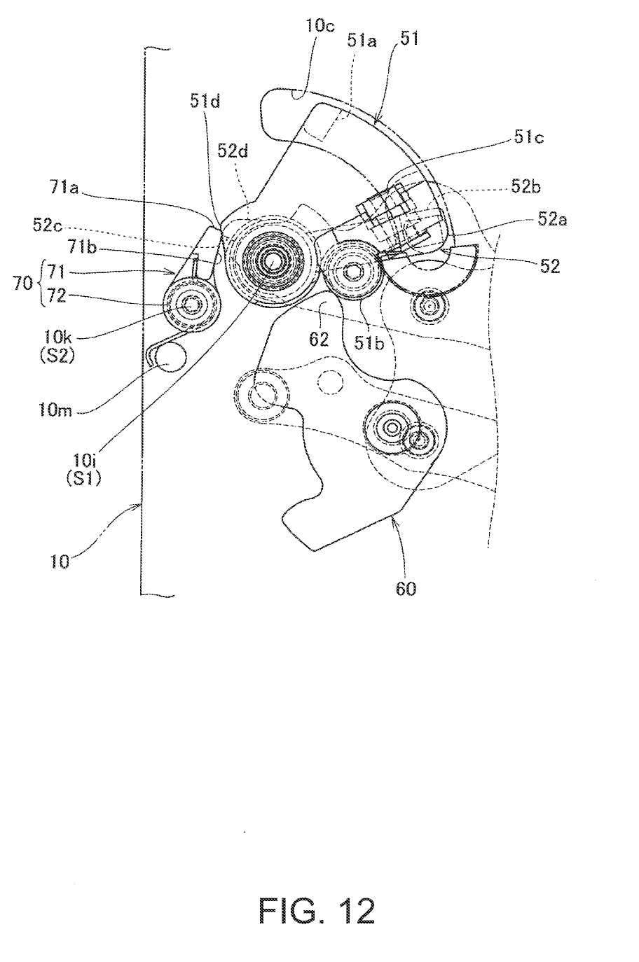

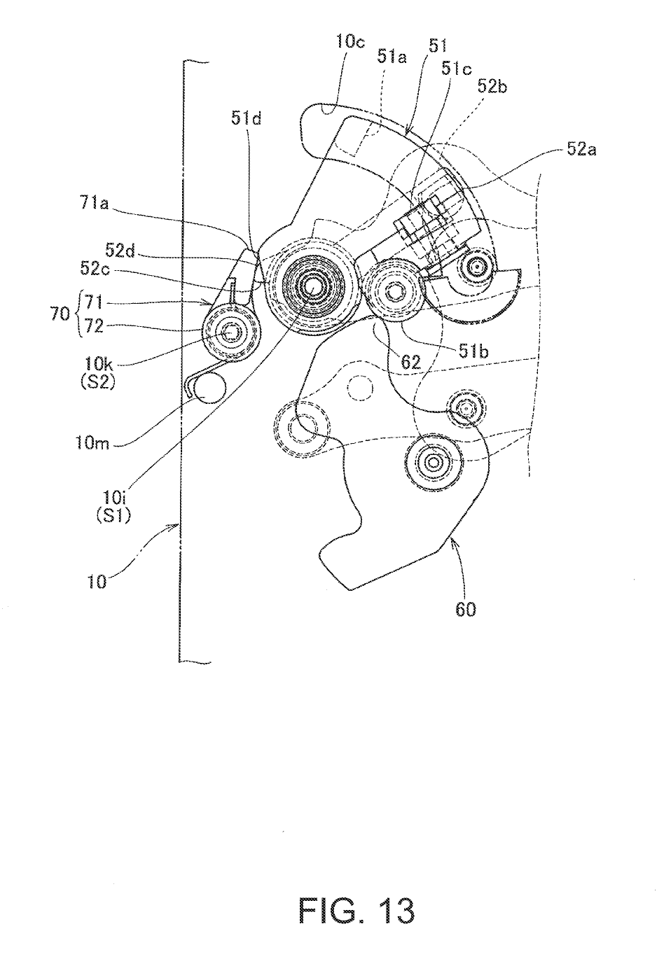

The second blade following driving member 52, as illustrated in FIG. 1 and FIG. 2, is provided with a driving pin 52a that is inserted into an elongated hole 10c and is connected to the arm 34, an engaging portion 52b for engaging detachably the engaging portion 51a of the second blade main driving member 51, a constrained portion 52c that is engaged detachably by the constraining portion 71a of the second blade constraining member 71, a sliding portion 52d, which is formed continuously with the constrained portion 52c, where on a portion (the side portion 71b) of the second blade constraining member 71 slides, and the like. The constrained portion 52c, as illustrated in FIG. 3 through FIG. 11, is formed so as to be engaged detachably by the constraining portion 71a of the second blade constraining member 71 so that the rotation of the second blade following driving member 52 in the counterclockwise direction will be constrained, so that the second blade 30 is held in the closed state. The sliding portion 52d, as illustrated in FIG. 12 and FIG. 13, is formed so that when the constraining portion 71a of the second blade constraining member 71 engages and disengages the constrained portion 52c, the side portion 71b of the second blade constraining member 71 slides. As a result, the second blade constraining member 71 slides the sliding portion 52d when the constraining portion 71a engages the constrained portion 52c, and slides the sliding portion 52d when the constraining portion 71a disengages from the constrained portion 52c, thus enabling a smooth constraining operation and a smooth operation for releasing the constraint by mitigating the impacts, and the like, when the second blade following driving member 52 (and the second blade 30) complete the shutter operation. That is, the second blade following driving member 52 is supported so as to be able to rotate around the supporting shaft 10i that defines the first axial line S1, relative to the bottom board 10, and is rotationally biased in the counterclockwise direction by the anti-backlash spring that prevents backlash of the second blade 30, so that the rotation in the counterclockwise direction is constrained by the second blade constraining member 71 over a prescribed interval of the setting operation by the setting member 60, where the release of the constraint by the second blade main driving member 51 prior to the completion of the setting operation causes a rotation in the counterclockwise direction, following the second blade main driving member 51 that rotates in the counterclockwise direction (which causes the second blade 30 to be in the released state), to be pushed by the second blade main driving member 51, through the engaging portion 52b, to rotate in the clockwise direction, where the driving pin 52a is stopped by contacting the shock absorbing member that is provided at the end portion of the elongated hole 10c.

The second blade driving spring 53 is a torsion coil-type spring, and, as illustrated in FIG. 2, is disposed around the supporting shaft 10i with one end side arranged so as to enable rotation around the supporting shaft 10i and is locked to a ratchet cylinder (not shown) that is supported by the ratchet pawl (not shown) of a support plate (not shown), (that is, one end side is blocked so as to prevent movement relative to the bottom board 10), where the other end side is locked to a portion of the second blade main driving member 51 so as to exert a biasing force on the second blade main driving member 51 for rotationally biasing in the clockwise direction in FIG. 2.

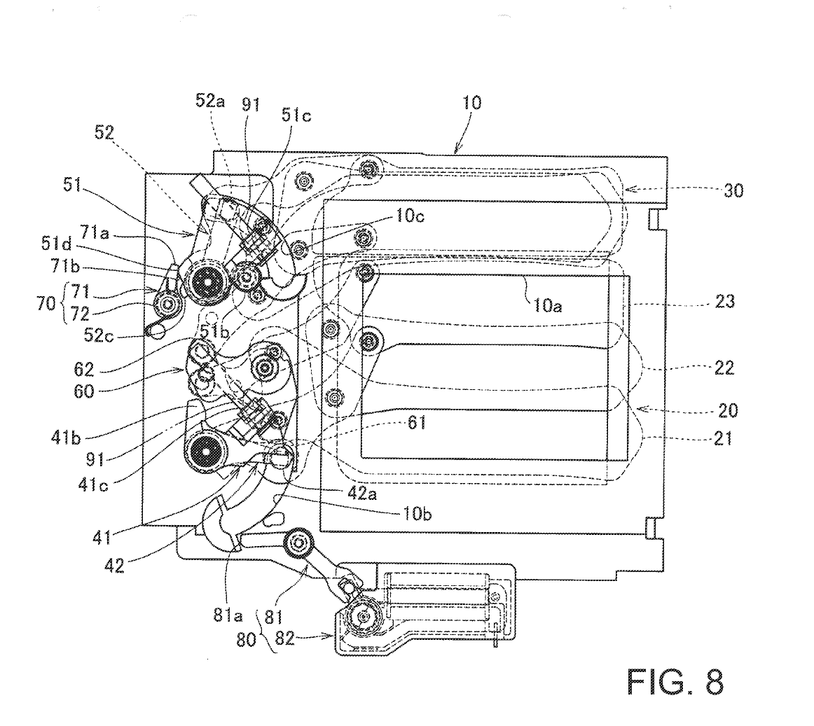

As illustrated in FIG. 1 and FIG. 2, the setting member 60 is provided with an engaging portion 61 able to engage the engaging portion 41b of the first blade main driving member 41, and an engaging portion 62 able to engage the engaging portion 51b of the second blade main driving member 51, and not only is supported rotatably by a supporting shaft 10j of the bottom board 10, but is also rotationally biased in the counterclockwise direction toward a standby position by a biasing force of a biasing spring (not shown). Moreover, when the setting member 60 is rotated in the clockwise direction from the standby position (the state wherein the shutter operation has been completed (the exposing operation has been completed)), shown in FIG. 2, against the biasing force of the biasing spring by the driving force that is applied by a driving mechanism (not shown), the engaging portion 61 exerts a rotational force on the engaging portion 41b and the engaging portion 62 exerts a rotational force on the engaging portion 51b, rotating the first blade main driving member 41 and the second blade main driving member 51 in the counterclockwise direction against the respective rotational biasing forces of the first blade driving spring 43 and the second blade driving spring 53, to carry out a setting operation that sets to the setting positioned prior to the shutter operation, while, on the other hand, when, in the setting position, in a state wherein (the attracted portions 41c and 51c of) the first blade main driving member 41 and the second blade main driving member 51 are attracted by the electromagnets 90 and 90, and are rotated back to the standby position by the biasing force of the biasing springs, then, as illustrated in FIG. 8, the engaging portion 61 disengages from the engaging portion 41b and the engaging portion 62 disengages from the engaging portion 51b, to produce a state wherein the first blade main driving member 41 and the second blade main driving member 51 can rotate in the clockwise direction.

The constraining mechanism 70, as illustrated in FIG. 10 through FIG. 13, is provided corresponding to the second blade driving mechanism 50, and is to constrain movement of the second blade following driving member 52, so as to hold the second blade 30 in a closed state, over a prescribed interval prior to the completion of the setting operation by the setting member 60, and is structured from the second blade constraining member 71, a biasing spring 72, and the like. The second blade constraining member 71, as illustrated in FIG. 10 through FIG. 13, is supported, relative to the bottom board 10, so as to be able to rotate around a supporting shaft 10k that defines a second axial line S2 and is provided with a constraining portion 71a that engages detachably the constrained portion 52c of the second blade following member 52, a side portion 71b whereon the sliding portion 52d of the second blade following driving member 52 slides, a locking portion 71c for locking the end portion of the biasing spring 72, and the like. The biasing spring 72, as illustrated in FIG. 10 through FIG. 14, is a torsion coil spring that is disposed around the supporting shaft 10k of the bottom board 10, where one and is locked to a locking pin 10n that extends from the bottom board 10, and the other end portion is locked to the locking portion 71c of the second blade constraining member 71, formed so as to bias (the constraining portion 71a of) the second blade constraining member 71 in the direction to cause engagement with (the constrained portion 52c of) the second blade following driving member 52.

Given the constraining mechanism 70, structured as described above, as illustrated in FIG. 11 through FIG. 13, when a setting operation is carried out by the setting member 60, from the state wherein the shutter operation is completed (wherein the exposing operation is completed), the constraining portion 71a of the second blade constraining member 71, as illustrated in FIG. 11, engages the constrained portion 52c of the second blade following driving member 52, to constrain the rotation of the second blade following driving member 52 in the counterclockwise direction, so that the second blade 30 will be maintained in the closed state, and, as illustrated in FIG. 12 and FIG. 13, the engagement of the cam portion 51d of the driving member 51 of the second blade releases the constraint of the second blade following driving member 52 by the second blade constraining member 71 prior to the completion of the setting operation, so that the second blade following driving member 52 will follow the second blade main driving member 51 (which is set to be setting positioned) due to the biasing force, so that the second blade 30 will be positioned in the open state. That is, the second blade 30 maintaining the opening portion 10a in a closed state over a prescribed interval after the completion of the shutter operation and prior to the completion of the setting operation enables the imaging information to be transferred to, and stored in, the storing portion in parallel with the setting operation, thus enabling high-speed continuous imaging. Here, in particular, an operation is carried out to release the second blade constraining member 52, by the second blade main driving member 51 that has been set by the setting member 60, so that, when compared to the structure wherein the constraint is released by the setting member, as is done conventionally, the design flexibility in the disposal of the various members is increased, enabling simplification of the structure, reduction of the components, miniaturization of the device, and the like, to be achieved.

Moreover, the constraining mechanism 70, when the second blade main driving member 51 and the second blade following driving member 52 are rotated in the clockwise direction and the second blade 30 completes the shutter operation, functions also as a stopping mechanism for stopping the movement, in the opposite direction, through rebounding of the second blade following driving member 52. That is, when the second blade 30 is held in the closed state by the constraining mechanism 70, the imaging information can be transferred and stored into the storing portion in parallel with the setting information, and the use of the constraining mechanism 70 as a stopping mechanism as well enables a stopping the fact that prevents rebound, and also enables a constraining effect for holding the second blade 30 in the closed state, while achieving a simplification of the structure and miniaturization of the device, and the like.

The second constraining mechanism 80, as illustrated in FIG. 2 and FIG. 3, is provided corresponding to the first blade driving mechanism 40, and is to constrain the movement of the first blade following driving member 42 so as to hold the first blade 20 in the open state over a prescribed interval until the completion of the setting operation by the setting member 60, and is structured from a first blade constraining member 81, an electromagnetic actuator 82, and the like. The first blade constraining member 81, as illustrated in FIG. 2 and FIG. 3, is supported so as to be able to rotate around a supporting shaft 10n of the bottom board 10, and is structured from a constraining portion 81a for engaging detachably the constrained portion 42c of the first blade following driving member 42, a U-shaped connecting portion 81b wherein (a connecting pin 82a′) of a rotor 82a, that is included in an electromagnetic actuator 82, and the like, are provided. The electromagnetic actuator 82, as illustrated in FIG. 2 and FIG. 3, is held on the bottom board 10, and is provided with a rotor 82a that has a connecting pin 82a′ that is connected to the connecting portion 81b of the first blade constraining member 81, an essentially U-shaped yoke 82b, a coil 82c for excitation, and the like. Additionally, the electromagnetic actuator 82 causes the rotor 82a to rotate in the clockwise direction, through the application of an electric current in one direction to the coil 82c, to cause the first blade constraining member 81 to rotate in the counterclockwise direction, to be positioned at a release position wherein the constraint of the first blade following driving member 42 is released, where the rotor 82a is rotated in the counterclockwise direction through the application of an electric current in the other direction to the coil 82c, to rotate the first blade constraining member 81 in the clockwise direction, to be positioned in a constraining position for constraining the movement of the first blade following driving member 42. In this way, the first blade 20 is held in the open state by the second constraining mechanism 80, making it possible to set a normally open mode wherein an electronic finder, or the like, can be used to observe an image of the photographic subject prior to imaging, and operations are carried out by driving the first blade constraining member 81 of the electromagnetic actuator 82 to apply a constraint or release the constraint, thus enabling the timing of the constraint and of the release of the constraint to be set easily and as appropriate depending on the desired control sequence.

Moreover, when the second constraining mechanism 80 is structured as to produce a detent torque for positioning the first blade constraining member 81 in the constraining position with the electromagnetic actuator 82 in the standby state (that is, for the electromagnetic actuator 82 exerts a driving force that moves the first blade constraining member 81 into the released positioned through applying an electric current to a coil, and moves the first blade constraining member 81 into the constrained position by cutting off the electric current from the coil), when the first blade main driving member 41 and the first blade following driving member 42 rotate in the clockwise direction and the first blade 20 has completed the shutter operation, then after the first blade following driving member 42 has first rotated the first blade constraining member 81 in the counterclockwise direction, the constraining portion 81a will oppose the constrained portion 42c, thus making it possible to function also as a stopping mechanism for stopping the movement in the opposite direction through the rebounding of the first blade following driving member 42. In this way, the use of the second constraining mechanism 80 as the second stopping mechanism enables a simplification of structure, a reduction of components, a miniaturization of the device, and the like, while providing both the stopping effect that prevents rebound and the constraining effect for holding the first blade 20 in the open state.

The two electromagnets 90 are held on a supporting plate (not shown) that is disposed in parallel to the bottom board 10, and, as illustrated in FIG. 1 and FIG. 2, are structured from, for example, four members 91 of prescribed lengths, and excitation coils (not shown) that are wrapped onto bobbins around the core members 91. Given this, as illustrated in FIG. 7 and FIG. 8, the application of an electric current to the coil produces lines of magnetic force that pass through the core member 91, producing a magnetic attractive force, toward the core members 91, in the attracted portions 41c and 51c of the first blade main driving member 41 and the second blade main driving member 51, which are set in the setting position, to hold the first blade main driving member 41 and the second blade main driving member 51 in the setting positions against the rotational biasing forces of the first blade driving spring 43 and the second blade driving spring 53, while, on the other hand, cutting the electric currents to the coils, enables the first blade main driving member 41 and the second blade main driving member 51 to each rotate in the clockwise direction, through the rotational biasing forces of the first blade driving spring 43 and the second blade driving spring 53.

The operation of this focal plane shutter will be explained next in reference to FIG. 2 through FIG. 9. First, in the standby state, after the completion of the shutter operation (after the completion of the exposing operation), the setting member 60, as illustrated in FIG. 2, is rotated in the counterclockwise direction by the biasing force of the biasing spring to be positioned in the standby position, where the first blade main driving member 41 and the first blade following driving member 42, which drive the first blade 20, are rotated in the clockwise direction by the rotational biasing force of the first blade driving spring 43 and are stopped, to position the first blade 20 at a position wherein the opening portion 10a is open, where the first blade constraining member 81 moves away from the first blade following driving member 42, to be positioned at a released position wherein the constraint is released, and where the second blade main driving member 51 and the second blade following driving member 52, which drive the second blade 30, are rotated in the clockwise direction by the rotational biasing force of the second blade driving spring 53 and are stopped, to position the second blade 30 at a position wherein the opening portion 10a is closed, where the second blade constraining member 71 positions the constraining portion 71a thereof at the constraining position that faces the constrained portion 52c of the second blade following driving member 52.

Here, when in a mode (the normally open mode) wherein it is possible to use an electronic finder to observe an image of the photographic subject prior to imaging, the second constraining mechanism 80, as illustrated in FIG. 3, is actuated so that the first blade constraining member 81 moves to the constraining position, to produce a state wherein movement is constrained by the constraining portion 81a opposing the constrained portion 42c of the first blade following driving member 42. Given this, when a command for preparing for the shutter operation is issued through a command for the setting operation, prior to an exposing operation, the setting member 60 begins the setting operation by rotating in the clockwise direction against the biasing force of the biasing spring and the first blade main driving member 41 and second blade main driving member 51 begin to rotate in the counterclockwise direction toward the setting position against the biasing forces of the first blade driving spring 43 and the second blade driving spring 53, and, as illustrated in FIG. 11, the constraining portion 81a of the constraining member 81 of the first blade engages the constrained portion 42c of the first blade following driving member 42, to constrain the movement of the first blade following driving member 42, so that the first blade 20 is held in a state wherein the opening portion 10a is open, and the constraining portion 71a of the second blade constraining member 71 engages the constrained portion 52c of the second blade following driving member 52, to constrain the movement of the second blade following driving member 52, so that the second blade 30 is held in a state wherein the opening portion 10a is closed.

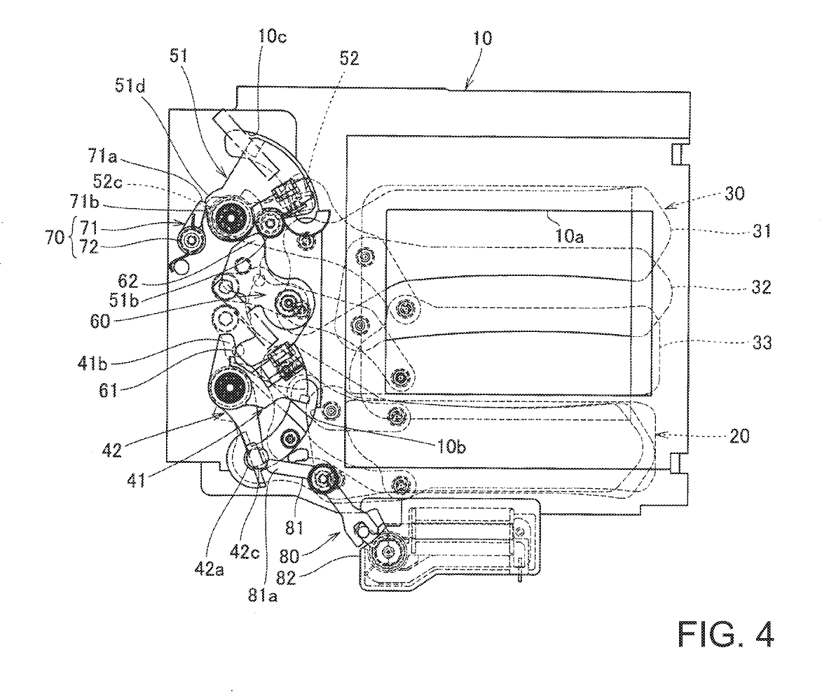

Additionally, as illustrated in FIG. 4 through FIG. 6, following the further rotation of the setting member 60 in the clockwise direction, the cam portion 51d of the second blade main driving member 51 engages the side portion 71b to rotate the second blade constraining member 71 in the counterclockwise direction, to release the constraint of the second blade following driving member 52 by the constraining portion 71a, so that the second blade following driving member 52 will be rotated in the clockwise direction, following the second blade main driving member 51, by the biasing force of the anti-backlash spring, and when the setting member 60 rotates further in the clockwise direction to complete the setting operation, then, as illustrated in FIG. 6, the second blades 30 will overlay each other to produce a state wherein the opening portion 10a is open. In this state, the image of the photographic subject can be checked using the electronic finder prior to imaging. Moreover, during the interval from the commencement of the setting operation by the setting member 60 until the constraint of the second blade following driving member 52 by the constraining mechanism 70 has been released (until the second blade 30 has closed the opening portion 10a), that is, in parallel with the setting operation, the imaging information can be transferred to, and stored in, the storing portion.

Following this, when a shutter operation (exposing operation) command is issued through a signal such as a release, then, as illustrated in FIG. 7, the electromagnetic actuator 82 of the second constraining mechanism 80 is activated (the rotor 82a is rotated in the clockwise direction), so that the constraining portion 81a of the first blade constraining member 81 disengages from the constrained portion 42c to release the constraint, and the first blade following driving member 42 is rotated in the counterclockwise direction, so as to follow the first blade main driving member 41, by the biasing force of the anti-backlash spring, so that the first blade 20 deploys so as to close the opening portion 10a. Following this, electric currents are applied to the two electromagnets 90, and the core members 91 and 91 attract the attracted portions 41c and 51c through magnetic attractive forces, so as to hold and position the first blade main driving member 41 and the second blade main driving member 51 in the setting positions against the biasing forces of the first blade driving spring 43 and the second blade driving spring 53 that provide a rotational bias in the clockwise direction, and, additionally, the setting member 60 is rotated in the counterclockwise direction by the biasing force of the biasing spring to return to the standby position, and the mechanical constraints on the first blade main driving member 41 and the second blade main driving member 51 are released.

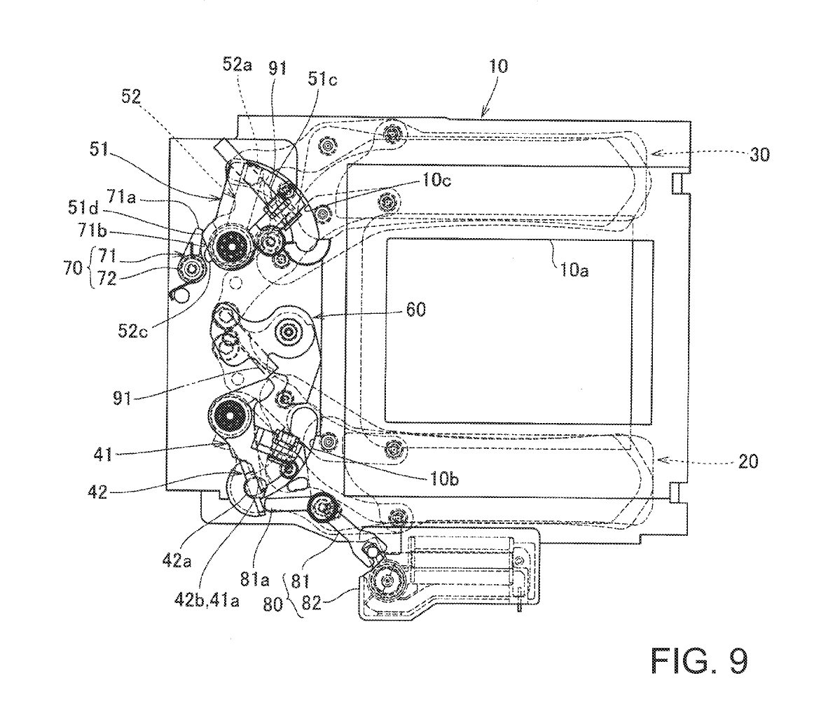

Thereafter, the electric currents to the two electromagnets 90 are each cut off at different desired timings to carry out a shutter operation (an exposing operation) wherein the first blade 20 opens the opening portion 10a in the second blade 30 closes the opening portion 10a, to arrive at a state wherein the shutter operation has been completed, as illustrated in FIG. 2. Specifically, first the electric current to the electromagnets 90 that corresponds to first blade driving mechanism 40 is cut, so that, as illustrated in FIG. 9, the first blade main driving member 41 is rotated in the clockwise direction, by the biasing force of the first blade driving spring 43, while pushing the first blade following driving member 42, so that the first blade 20 opens the opening portion 10a. Following this, the electric current to the electromagnet 90 corresponding to the second blade driving mechanism 50 is cut so that the second blade main driving member 51 is rotated in the clockwise direction by the biasing force of the second blade driving spring 53, while pushing the second blade following driving member 52, so that the second blade 30 closes the opening portion 10a. When the second blade following driving member 52 rotates in the clockwise direction and stops, the sliding portion 52d of the second blade following driving member 52 slides on the side portion 71b of the second blade constraining member 71, to produce a state wherein the constrained portion 52c thereof opposes the constraining portion 71a. As a result, this can produce an effect of constraining the second blade following driving member 52 (and the second blade 30), and also prevents movement in the opposite direction due to rebound.

Note that in the case of a mode (the normally closed mode) wherein the image of the photographic subject cannot be observed using the electronic finder prior to imaging, the same operation as described above is carried out in a state wherein the constraint of the first blade following driving member 42 by the second constraining mechanism 80 is released.

Given the focal plane shutter structured as set forth above, carrying out the operation wherein the second blade constraining member 71 is released by the second blade main driving member 51 that is set by the setting member 60, when compared to a structure wherein the constraint is released by the setting member, as is done conventionally, increases the design flexibility with which the various members are arranged, enabling a simplification of structure, a reduction of components, and a miniaturization of the device.

While in the example set forth above a case was illustrated wherein the constraining mechanism 70 that included a second blade constraining member 71 that rotates around the second axial line S2, and a biasing spring 72, was employed as the constraining mechanism, there is no limitation thereto, but rather insofar as the movement of the second blade following driving member 52, which holds the second blade 30 in the closed state, can be constrained, a constraining mechanism of another form may be used. While, in the example set forth above, a case was illustrated wherein the present invention is employed in a structure wherein a first blade 20 and a second blade 30 are included as blade members, there is no limitation thereto, but rather the present invention may be employed in a structure that is provided with a single blade member (a single curtain, for example, only the second blade 30) insofar as the two driving members, that is the main driving member and the following driving member, are included as the driving mechanism for driving the blade member.

As described above, the focal plane shutter according to the present invention enables the achievement of a simplification in structure, a reduction in components, and a miniaturization of the device while enabling the imaging information to be transferred and stored during the setting operation, to enable high-speed, continuous imaging, and enables the observation of an image of the photographic subject using an electronic finder prior to imaging, and thus can be applied, of course, to digital cameras such as digital single lens cameras and mirrorless cameras, and also to other optical instruments that have opening portions for performing exposure.

1. A focal plane shutter comprising:
a bottom board having an opening portion for exposing;
a blade member that opens/closes the opening portion;
a main driving member that biases the blade member in a direction of carrying out a shutter operation;
a setting member that sets the main driving member to a setting position for prior to the shutter operation, against a biasing force;
a following driving member that is connected to the blade member and that is biased so as to follow the main driving member that is set to the setting position, and that is pushed by the main driving member so as to move at a time of the shutter operation; and
a constraining mechanism that constrains movement of the following driving member so as to hold the blade member in a closed state, wherein:
the constraining mechanism includes a constraining member that engages the following driving member and that is biased so as to constrain the movement thereof, and that is moved so as to release the constraint through engaging the main driving member prior to completion of a setting operation by the setting member.

2. The focal plane shutter as set forth in claim 1, wherein:
the following driving member is supported so as to be rotatable around a first axial line, and has a constrained portion for which movement is constrained by engaging with the constraining member;
the constraining member is supported so as to be rotatable around a second axial line and has a constraining portion for constraining movement by engaging the constrained portion of the following driving member; and
the main driving member is supported so as to be rotatable around the first axial line, and has a cam portion that engages the constraining member so as to exert a cam effect in the direction of releasing the constraint.

3. The focal plane shutter as set forth in claim 2, wherein:
the following driving member has a sliding portion that is formed continuously with the constrained portion, for sliding on a portion of the constraining member when the constraining portion engages or releases the constrained portion.

4. The focal plane shutter as set forth in claim 1, further comprising:
a stopping mechanism that stops movement of the following driving member in an opposite direction at a completion of the shutter operation by the blade member, wherein:
the constraining mechanism acts also as the stopping mechanism.

5. The focal plane shutter as set forth in claim 1, wherein:
the blade member includes a first blade that opens the opening portion and a second blade that closes the opening portion at the time of a shutter operation;
the main driving member includes a first blade main driving member corresponding to the first blade and a second blade main driving member corresponding to the second blade;
the following driving member includes a first blade following driving member corresponding to the first blade and a second blade following driving number corresponding to the second blade;
the constraining mechanism includes a second blade constraining member that is biased so as to engage the second blade following driving member so as to constrain the movement thereof and that moves so that the constraint, through the engagement of the second blade main driving member, is released prior to the completion of the setting operation by the setting member.

6. The focal plane shutter as set forth in claim 5, further comprising:
a second constraining mechanism that constrains movement of the first blade following driving member so as to hold the first blade in an open state.

7. The focal plane shutter as set forth in claim 6, wherein:
the second constraining mechanism includes a first blade constraining member that engages the first blade following driving member so as to constrain the movement thereof, and an electromagnetic actuator that drives the first blade constraining member.

8. The focal plane shutter as set forth in claim 6, further comprising:
a second stopping mechanism that stops the movement of the first blade following driving member in the opposite direction at the completion of the shutter operation by the first blade, wherein:
the second constraining mechanism acts also as the second stopping mechanism.

9. A camera comprising:
a focal plane shutter comprising:
a bottom board having an opening portion for exposing;
a blade member that opens/closes the opening portion;
a main driving member that biases the blade member in a direction of carrying out a shutter operation;
a setting member that sets the main driving member to a setting position for prior to the shutter operation, against a biasing force;
a following driving member that is connected to the blade member and that is biased so as to follow the main driving member that is set to the setting position, and that is pushed by the main driving member so as to move at a time of the shutter operation; and
a constraining mechanism that constrains movement of the following driving member so as to hold the blade member in a closed state, wherein:
the constraining mechanism includes a constraining member that engages the following driving member and that is biased so as to constrain the movement thereof, and that is moved so as to release the constraint through engaging the main driving member prior to completion of a setting operation by the setting member.
